(19) United States
(12) Patent Application Publication
(10) Pub. No.: US 2014/0240071 A1
(43) Pub. Date: Aug. 28, 2014

(54) 3D PRINTED INDUCTOR

(71) Applicant: ENTROPIC COMMUNICATIONS, INC., San Diego, CA (US)

(72) Inventor: Martin Alderton, San Diego, CA (US)

(73) Assignee: ENTROPIC COMMUNICATIONS, INC., San Diego, CA (US)

(21) Appl. No.: 13/777,828

(22) Filed: Feb. 26, 2013

(51) Int. Cl. H01F 17/00

(52) U.S. Cl. CPC H01F 17/0013
USPC 336/200

(57) ABSTRACT

An apparatus with an inductor having a conductive loop perpendicular to a metalization plane of a substrate. The conductive loop has an upper element and lower element both parallel to the metalization plane that are connected with a via.

### BACKGROUND

1. Technical Field

Aspects of the present disclosure relate in general to electronic circuitry. In particular, aspects of the disclosure include a three-dimensional (3D) printed inductor formed perpendicular to metalization planes of a substrate.

2. Description of the Related Art

An inductor (sometimes also referred to as a “choke,” “coil” or “reactor”) is a passive two-terminal electrical component that stores energy in its magnetic field. Typically any conductor has inductance although the conductor is typically wound in loops to reinforce the magnetic field. Due to the time-varying magnetic field inside the coil, a voltage is induced, according to Faraday's law of electromagnetic induction, which by Lenz's law opposes the change in current that created it. Inductors are one of the basic components used in electronics where current and voltage change with time, due to the ability of inductors to delay and reshape alternating currents. The quality factor (or Q) of an inductor is the ratio of its inductive reactance to its resistance at a given frequency, and is a measure of its efficiency. The higher the Q factor of the inductor, the closer it approaches the behavior of an ideal, lossless, inductor.

A Printed Circuit Board (PCB) is a board that mechanically supports and electrically connects electronic components using conductive pathways laminated onto a non-conductive substrate. In addition to connecting electrical components, a two-dimensional (planar) inductor 1100 can be printed on to a printed circuit board, as shown in FIG. 1A. Typically, such printed planar inductors 1000 are a geometric spiral-type shape printed on a single plane of the printed circuit board 1100, as shown in FIG. 1B. These structures result in a current loop that is parallel to the metallization planes of the Printed Circuit Board substrate. Unfortunately, the series resistance of printed planar inductors 1000 results in a low quality factor as electrical current is converted into heat. Additionally planar inductors 1000 occupy a substantial amount of surface area, limiting their usefulness in high-density applications.

### SUMMARY

An apparatus with an inductor having a conductive loop perpendicular to a metalization plane of a substrate. The conductive loop has an upper element and lower element both parallel to the metalization plane that are connected with a via.

### DESCRIPTION OF THE DRAWINGS

FIGS. 1A and 1B depict a planar inductor of the PRIOR ART.

FIG. 2 illustrates three-dimensional printed inductor embodiment.

FIG. 3 is a diagram of a three-dimensional printed inductor embodiment with a single turn.

FIG. 4 is a diagram of a three-dimensional printed inductor embodiment with a two turns.

FIG. 5 is a diagram used to illustrate the calculation of inductance for a three-dimensional printed inductor embodiment constructed with rectangular elements.

FIG. 6 is a diagram used to illustrate the calculation of inductance for a three-dimensional printed inductor embodiment constructed with tubular elements.

FIG. 7 is a diagram used to illustrate the calculation of inductance for a three-dimensional printed inductor embodiment constructed with rectangular elements and tubular vias.

FIG. 8 illustrates a embodiment made up of a pair of coupled three-dimensional printed inductors.

FIG. 9 illustrates a transformer embodiment made up of two three-dimensional printed inductors.

FIGS. 10A-B illustrates a simulation of a pair of single coupled in transmission or isolation.

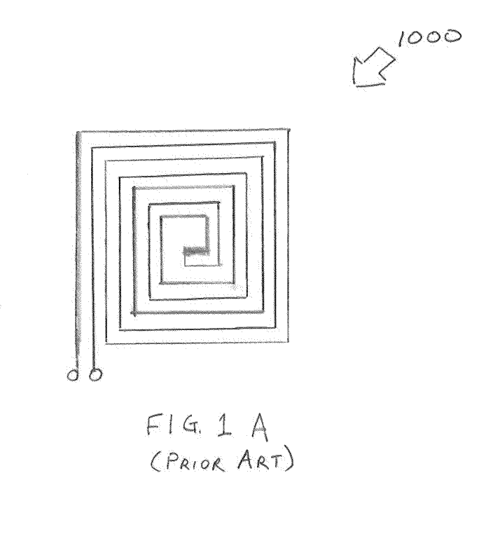

### DETAILED DESCRIPTION

One aspect of the present disclosure is the realization that traditional inductors are limited because they have a current loop (also referred interchangeably as a “turn”) formed that is parallel to the metallization planes of a substrate.

Another aspect of the present disclosure includes the realization that inductors may be fabricated within a printed circuit board in three-dimensions with loops formed perpendicular to metalization planes of a substrate, resulting a high quality factor inductor.

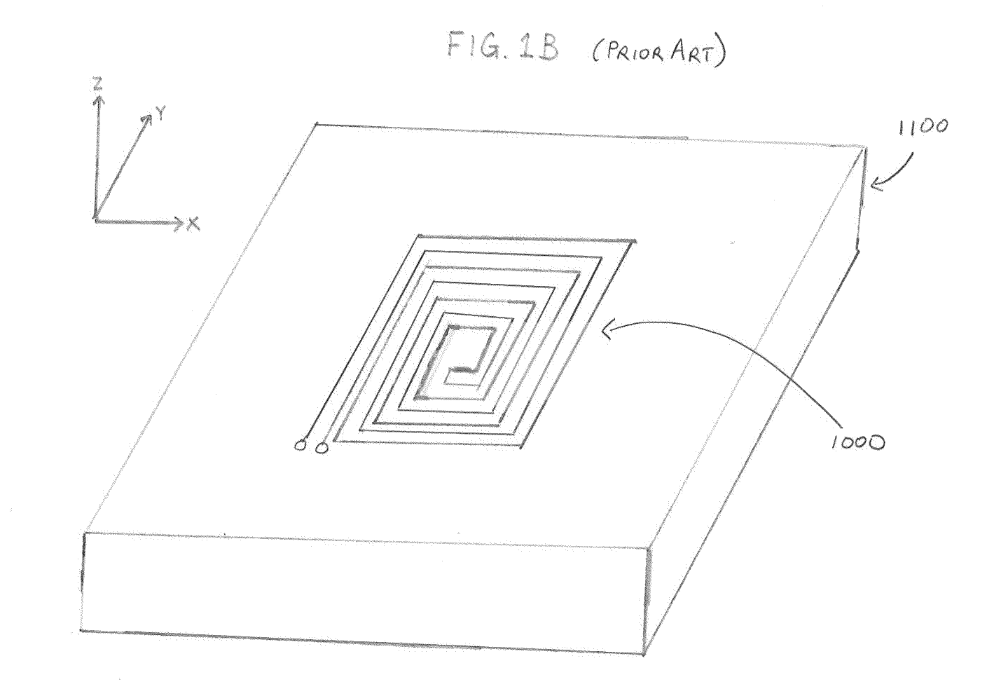

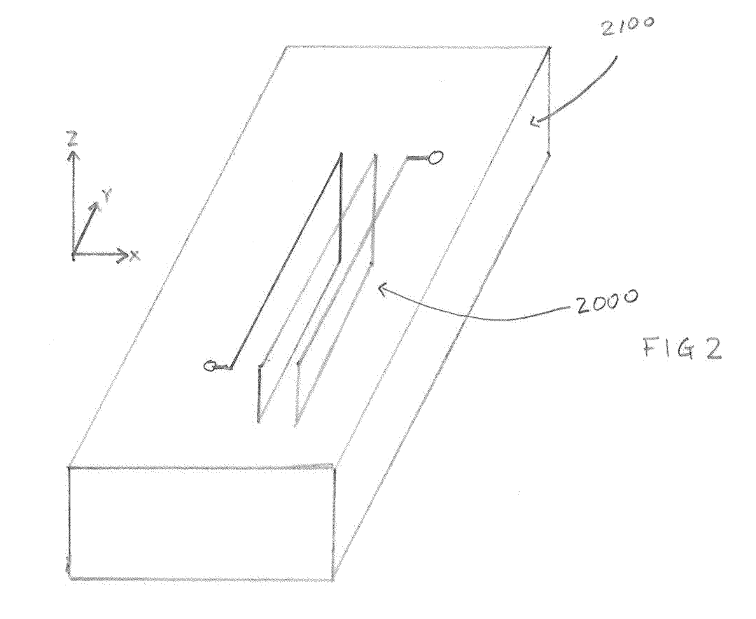

FIG. 2 conceptually illustrates a three-dimensional printed inductor 2000 embodiment, constructed and operative in accordance with an embodiment of the present disclosure. In this figure, three-dimensional inductor 2000 is an inductor printed with loops formed perpendicular to metalization planes of a substrate. For illustrative purposes, two inductor loops are depicted; it is understood by those practiced in the art that any number of inductor loops may be used in 3D inductor 2000. The number, size, and area of loops may be adjusted according to the characteristics required from the 3D inductor 2000.

It is understood that any substrate may be used, such as a Printed Circuit Board substrate or a semiconductor substrate (including, but not limited to a silicon (Si) or gallium arsenide (GaAs) substrate). For illustrative purposes only, we will describe Printed Circuit Board embodiments.

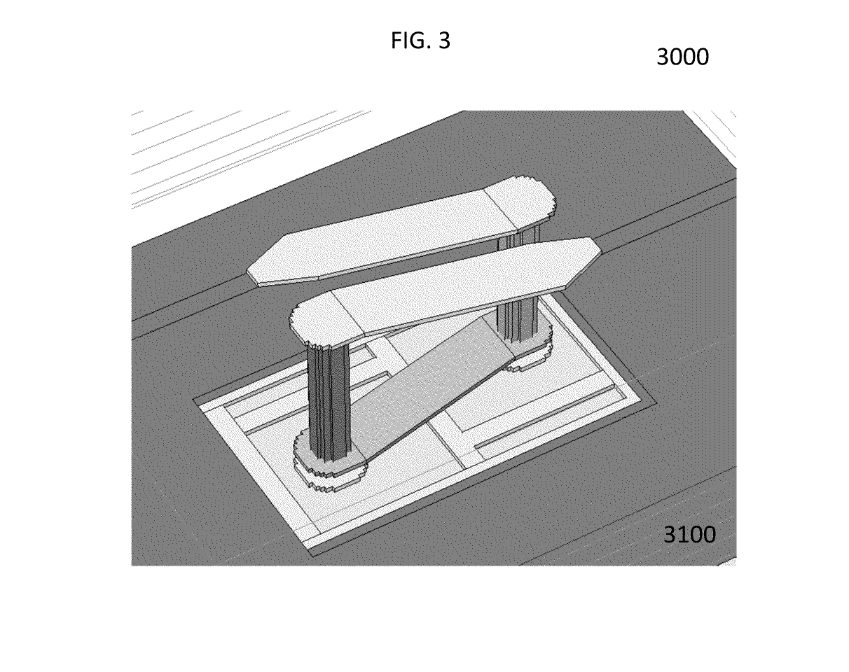

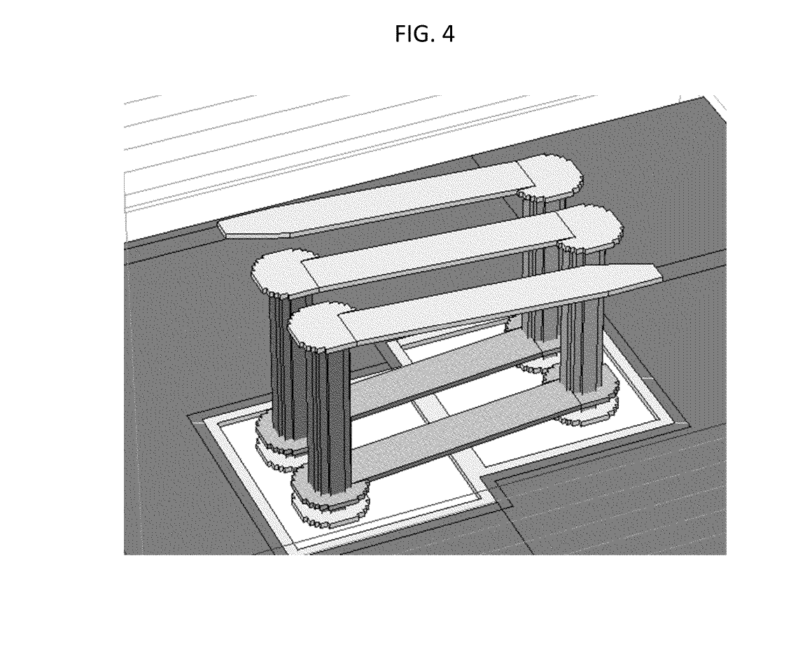

FIG. 3 is a diagram of the three-dimensional printed inductor 3000 embodiment, constructed and operative in accordance with an embodiment of the present disclosure. In this figure, three-dimensional inductor 3000 is an inductor printed within printed circuit board 3100, and the loops are formed perpendicular to metalization planes of the printed circuit board 3100 substrate. For illustrative purposes, a single inductor loop is depicted; it is understood by those practiced in the art that any number of inductor loops may be used in 3D inductor 3000. An example multi-loop inductor with two turns is depicted in FIG. 4, constructed and operative in accordance with an embodiment of the present disclosure.

Returning to FIG. 3, the inductor 3000 itself may be made of any conductive material used in the fabrication of a printed circuit board 3100. Example conductors include copper, gold, aluminum, or any other conductor known in the art.

The printed circuit board 3100 may comprise insulating layers of dielectric laminated together with epoxy resin prepreg. The dielectric may be selected upon different insulating values, depending on the requirements of the circuit. Example dielectrics include polytetrafluoroethylene (ex. Teflon™), woven fiberglass with an epoxy resin (ex. FR-1 or FR-4), or composite epoxy material (“CEM”).

Accordingly, inductor 3000 is printed on multiple layers of the printed circuit board 3100 forming upper and lower parts of a loop. The layers are connected with vias to connect the upper and lower parts to form the loop.

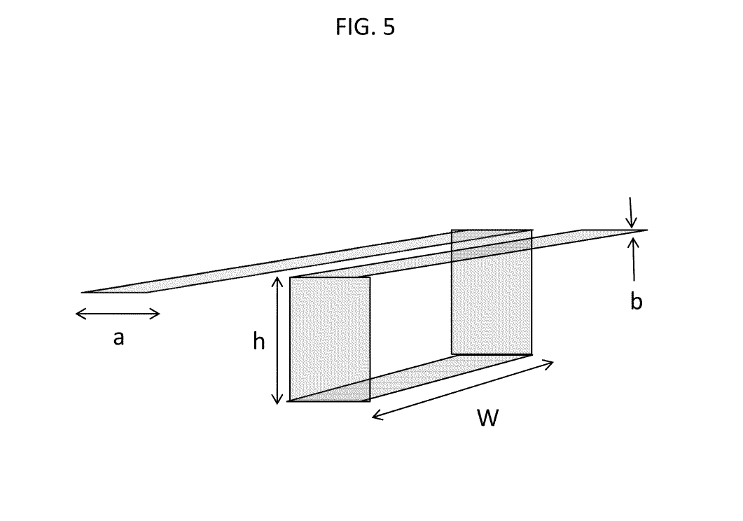

The inductance of an inductor 3000 embodiment is dependent upon the actual dimensions of the device. As is understood in the art, an electro-magnetic simulator may be used to find the inductance, Q, and self-resonant frequency (SRF). However, empirical equations may be used to approximate inductance calculations for inductor embodiments. FIGS. 5-7 describe inductance approximations for single loop inductors with a variety of different dimensions.

FIG. 5 is a diagram used to illustrate the inductance approximation of for a three-dimensional printed inductor embodiment constructed with rectangular elements, constructed and operative in accordance with an embodiment of the present disclosure. In such an embodiment, the inductor may be thought of as made of a single rectangular loop of rectangular wire. The inductance of such a wire may be approximated as:

L_{rect}≈N²μᵣμₒ/π{hln(2h/(a+b))+wln(2w/(a+b))−wln((w+d)/h)−hln((h+d)/w)−(w+h)/2+2d+0.45(a+b)}

where

L_{rect} is the inductance in nanoHenries,

N=number of turns (Note that number of turns need not be an integer, but must be close to 1.),

μᵣμₒπ=400,

w, h are width and height of the loop respectively,

d is the diagonal (calculated as the square root of (w²+h²)), in meters, and

a, b are the width and thickness of the rectangular wire, in meters.

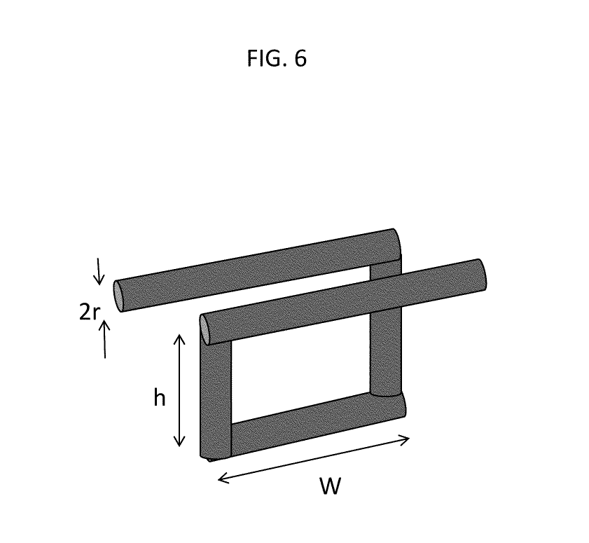

FIG. 6 is a diagram used to illustrate the calculation of inductance for a three-dimensional printed inductor embodiment constructed with tubular elements, constructed and operative in accordance with an embodiment of the present disclosure. In this embodiment, a rectangular inductor is made of a wire with a radius of “r.” The inductance of such a wire may be approximated as:

L_{tubular}≈N²μᵣμₒ/π{hln(2h/r)+wln(2w/r)−wln((w+d)/h)−hln((h+d)/w)−2(w+h)+2d}

L_{tubular} is the inductance in nanoHenries,

N=number of turns (Note that number of turns need not be an integer, but must be close to 1.),

μᵣμₒ/π=400,

w, h are width and height of the loop respectively,

d is the diagonal (calculated as the square root of (w²+h²)), in meters, and

r is the radius of the round wire, in meters.

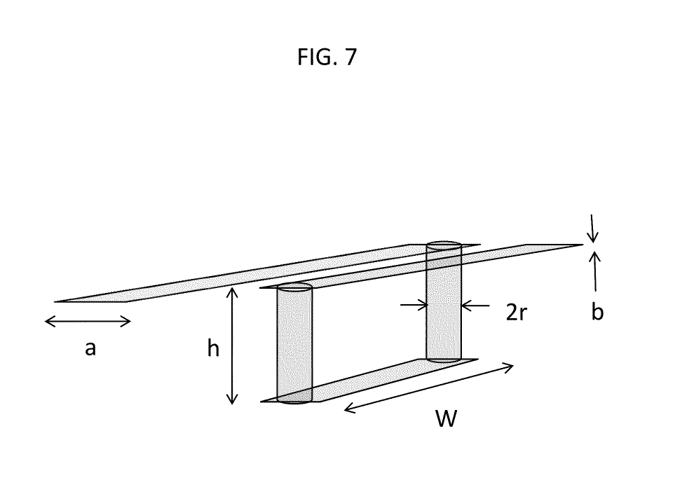

FIG. 7 is a diagram used to illustrate the calculation of inductance for a three-dimensional printed inductor embodiment constructed with rectangular elements and tubular vias, constructed and operative in accordance with an embodiment of the present disclosure. In this embodiment, a hybrid rectangular inductor is made of rectangular elements connected by vias with a radius of “r.” The inductance of such a wire may be approximated as:

L_{hybrid}≈N²μᵣμₒ/π{hln(2h/r)+wln(2w/(a+b))−wln((w+d)/h)−hln((h+d)/w)−(2w+h/2)+2d+0.45(a+b)}

L_{hybrid} is the inductance in nanoHenries,

N=number of turns (Note that number of turns need not be an integer, but must be close to 1.),

μᵣμₒ/π=400,

w, h are width and height of the loop respectively,

d is the diagonal (calculated as the square root of (w²+h²)), in meters,

a, b are the width and thickness of the rectangular wire, in meters, and

r is the radius of the round wire, in meters.

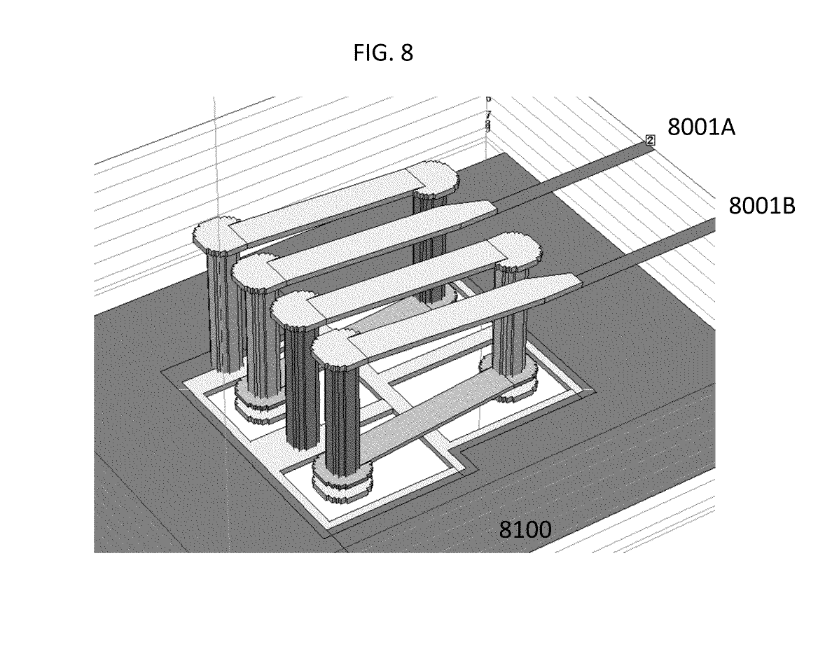

Expanding upon the concepts described in the above, it is understood that three-dimensional printed inductors may be used in a variety of different ways, all fully compliant with the embodiments described herein. For example, FIG. 8 illustrates a embodiment made up of a pair of coupled three-dimensional printed inductors with loops that are perpendicular to metalization planes of a printed circuit board 8100 substrate, constructed and operative in accordance with an embodiment of the present disclosure. In this figure, a pair of three-dimensional inductors 8001A and 8001B is an inductor printed within printed circuit board 8100. For illustrative purposes, the two coupled inductor loops are depicted; it is understood by those practiced in the art that any number of inductor loops may be used. The number, size, and area of loops may be adjusted according to the characteristics required by the circuit.

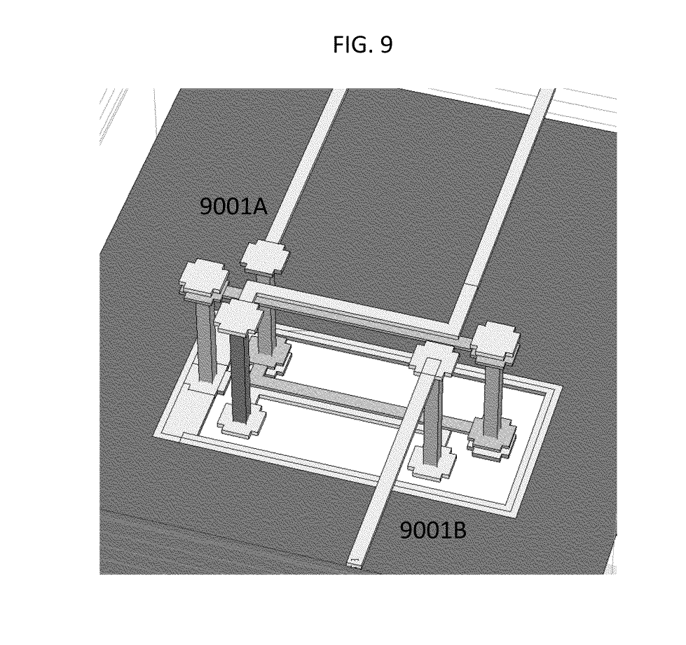

In one aspect of the present disclosure includes the realization that, if a pair of printed inductors can be magnetically coupled, and that their coupling is strong enough, then a high frequency balun and/or transformer can be created. FIG. 9 illustrates a transformer embodiment made up of two three-dimensional printed inductors (9001A and 9001B), constructed and operative in accordance with an embodiment of the present disclosure. For illustrative purposes only, inductors 9001A and 9001B are single turn inductors; it is understood by those familiar with the art that each of the inductors 9001A and/or 9001B may implemented using single or multi-turn inductors with loops that are perpendicular to metalization planes of the substrate. Such an embodiment eliminates the cost of a discrete balun element. Furthermore, depending upon the design of the balun/transformer, there can be an insertion los advantage, given the high Q's that may be realized.

In another aspect, magnetic and electric couplings between inductor pairs 9001A and 9001B can be constructive or destructive, depending on the winding polarity between the inductors—i.e. whether both inductors are wound in the same direction or in opposite directions.

Furthermore, simply by reversing the sense of an inductor (which may be done using a switch matrix integrated circuit), it is possible to achieve either transmission or isolation.

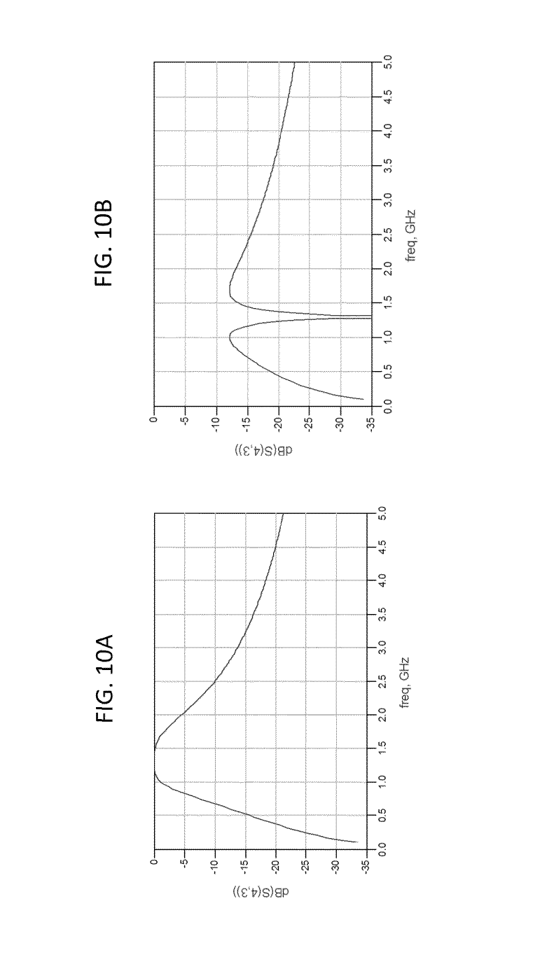

Responses in the two states, for a rudimentary and easy to realizable example (a single coupled inductor pair, Sonnet simulation) is shown at FIGS. 10A and 10B.

Embodiments of the three-dimensional inductor allow the implementation of switched filter banks or cascades that, under control of an integrated circuit, may pass or reject signals in any desired frequency band. Furthermore, embodiments also enable: radio-frequency (RF) switches with a very low loss, as there is no series loss element, switches with high linearity and no large RF swings at an integrated circuit switch matrix.

Finally, the three-dimensional inductor embodiments are easily integrated with printed filter designs.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the current disclosure is not intended to be limited to the embodiments shown herein, but is to be accorded the widest scope consistent with the principles and novel features disclosed herein.

1. An apparatus comprising:
a substrate with a metalization plane parallel to a surface of the substrate;
a first inductor with a first conductive loop perpendicular to the metalization plane of the substrate; and
a second inductor with a second conductive loop perpendicular to the metalization plane of the substrate,
wherein the first inductor is magnetically coupled to the second inductor as a balun or transformer.

2. The apparatus of claim 1 wherein the first conductive loop further comprises:
a first upper element parallel to the metalization plane;
a first lower element parallel to the metalization plane; and
a first to coupling the upper element and the lower element, the first via perpendicular to the metalization on plane.

3. The apparatus of claim 1, wherein all portions of both the first conductive loop and the second conductive loop are constructed with tubular elements.

4. The apparatus of claim 1, wherein the second conductive loop further comprises:
a second upper element parallel to the metalization plane;
a second lower element parallel to the metalization plane; and
a second via coupling the upper element and the lower element, the second via perpendicular to the metalization plane.

5. The apparatus of claim 4, wherein the first inductor and the second inductor are wound in opposite directions.

6. The apparatus of claim 4, wherein the substrate is a semiconductor substrate.

7. The apparatus of claim 4, wherein the first conductive loop is made of copper, gold, or aluminum.

8. The apparatus of claim 4, wherein the substrate is a printed circuit board substrate.

9. The apparatus of claim 8, wherein the first conductive loop is made of copper, gold, or aluminum.

10. The apparatus of claim 1, further comprising a switch matrix integrated circuit that reverses the sense of the first inductor or the second inductor.

11. The apparatus of claim 10, wherein the substrate is a semiconductor substrate.

12. The apparatus of claim 10, wherein the first conductive loop is made of copper, gold, or aluminum.

13. The apparatus of claim 10, wherein the substrate is a printed circuit board substrate.

14. The apparatus of claim 13, wherein the first conductive loop is made of copper, gold, or aluminum.

15. An apparatus comprising:
a substrate with a metalization plane parallel to a surface of the substrate;
a first inductor with a first conductive loop perpendicular to the metalization plane of the substrate, wherein all portions of the first conductive loop are constructed with tubular elements.

16. The apparatus of claim 15, wherein the first conductive loop further comprises:
a first upper element parallel to the metalization plane;
a first lower element parallel to the metalization plane; and
a first via coupling the upper element and the lower element, the first via perpendicular to the metalization plane.
